(19) United States
(12) Patent Application Publication
(10) Pub. No.: US 2026/0247011 A1
(43) Pub. Date: Aug. 20, 2026

(54) SERVER AND COMPUTER PROGRAM

(71) Applicant: 17LIVE Japan Inc., Tokyo (JP)

(72) Inventors: Yun Chen LIU, Tokyo (TW); Yu-Chuan CHANG, Tokyo (TW); Qiaoyi XU, Tokyo (TW); Chen-Yu CHENG, Tokyo (TW); Cheng-Hsiang WENG, Tokyo (TW)

(21) Appl. No.: 19/462,595

(22) Filed: Jan. 28, 2026

(30) Foreign Application Priority Data
Feb. 19, 2025 (JP) 2025-025431
Feb. 19, 2025 (JP) 2025-053029

(51) Int. Cl. H04N 21/81; G06T 13/20; G06T 13/40; G10L 25/63; H04N 21/2187; H04N 21/233

(52) U.S. Cl. CPC H04N 21/8146; G06T 13/205; G06T 13/40; G10L 25/63; H04N 21/2187; H04N 21/233

(57) ABSTRACT

A server comprises a circuitry, wherein the circuitry is configured to: receive, from a mobile terminal via a network, image data obtained from a rear camera of the mobile terminal of a streamer of a live stream and audio data obtained from a microphone of the mobile terminal; determine a movement of an avatar of the streamer based on the obtained audio data; and synthesize the obtained image data and data of the avatar such that the avatar is superimposed on an image represented by the obtained image data and the avatar realizes the determined movement.

### CROSS-REFERENCE TO RELATED APPLICATIONS

This application is based on and claims the benefit of priority from Japanese Patent Application Serial No. 2025-053029 (filed on Mar. 27, 2025) and No. 2025-025431 (filed on Feb. 19, 2025), the contents of which are hereby incorporated by reference in their entirety.

### BACKGROUND

### Technical Field

The present disclosure relates to a server and a computer program.

### Description of the Prior Art

The mode of information exchange has shifted with the development of IT technology. In the Showa era, one-way information transmission such as newspapers and television was dominant. In the Heisei era, with the spread of mobile phones and personal computers and significant improvements in internet communication speeds, instant two-way communication services such as chat services emerged. Additionally, with the reduction of storage costs, on-demand video distribution services gained acceptance. Now, in the Reiwa era, with the higher functionality of smartphones and further improvements in network speeds represented by 5G, services realizing real-time communication via video, particularly live streaming services, are rapidly gaining recognition. Live streaming services are expanding their user base, centering on young people, as a service that allows people to share the same enjoyable time even when apart.

Non-Patent Document 1 describes, in an app that controls an avatar via face tracking, using the scenery from a back camera as a background when viewing a model in 3D space, and reflecting the video from the back camera in the background in real-time.

[Non-Patent Document 1]: “Trying out all apps that let you become a Vtuber on a smartphone,” Kujo Ringo, Jun. 2, 2020, URL: https://note.com/ringo_0_0_5/n/n57d09e66e84b

### SUMMARY

As described in Non-Patent Document 1, there is a demand for performing streaming using an avatar while using an image from a rear camera as a background image. However, general smartphones technically do not support turning on the front camera and the rear camera simultaneously. Therefore, with the conventional method of controlling the movement of an avatar by analyzing the face of the streamer captured by the front camera, it is difficult to support streaming by an avatar using an image from the rear camera as a background image.

The present disclosure has been made in view of such issues, and an object thereof is to provide a technology capable of improving the control of an avatar in live streaming using an avatar with a real-world image as a background.

One aspect of the present invention relates to a server. This server comprises: a receiving unit configured to receive, from a mobile terminal via a network, image data obtained from a rear camera of the mobile terminal of a streamer of a live stream and audio data obtained from a microphone of the mobile terminal; a determining unit configured to determine a movement of an avatar of the streamer based on the obtained audio data; and a synthesizing unit configured to synthesize the obtained image data and data of the avatar such that the avatar is superimposed on an image represented by the obtained image data and the avatar realizes the determined movement.

Another aspect of the present invention is a computer program. This computer program causes a mobile terminal of a streamer of a live stream, which comprises a rear camera, a front camera, a microphone, and a display, to realize: a function of transmitting image data obtained from the rear camera to a server via a network; a function of deactivating the front camera during the live stream; a function of transmitting audio data obtained from the microphone to the server via the network; and a function of causing the display to display an image in which an avatar is superimposed on an image represented by the transmitted image data and the avatar realizes a movement determined based on the transmitted audio data.

Note that any arbitrary combination of the above components, and mutual substitution of components or expressions of the present invention among a method, an apparatus, a system, a computer program, a recording medium storing a computer program, and the like, are also effective as aspects of the present invention.

According to an embodiment of the present invention, it is possible to improve the control of an avatar in live streaming using an avatar with a real-world image as a background.

### BRIEF DESCRIPTION OF THE DRAWINGS

FIG. 1 A schematic diagram showing the configuration of a live streaming system according to an embodiment.

FIG. 2 A block diagram showing the function and configuration of the user terminal in FIG. 1.

FIG. 3 A block diagram showing the function and configuration of the server in FIG. 1.

FIG. 4 A data structure diagram showing an example of the Stream DB in FIG. 3.

FIG. 5 A data structure diagram showing an example of the User DB in FIG. 3.

FIG. 6 A data structure diagram showing an example of the Gift DB in FIG. 3.

FIG. 7 A data structure diagram showing an example of the Avatar DB in FIG. 3.

FIG. 8 A schematic diagram for explaining data processing in fusion streaming.

FIG. 9 A representative screen diagram of a streaming preparation screen displayed on the display of a user terminal of a streamer who is about to start fusion streaming.

FIG. 10 A representative screen diagram of the streaming preparation screen displaying three selectable objects.

FIG. 11 A representative screen diagram of the streaming preparation screen displayed on the display of the user terminal of the streamer.

FIG. 12 A representative screen diagram of a live streaming room screen displayed on the display of a user terminal of a viewer of fusion streaming.

FIG. 13 A representative screen diagram of a live streaming room screen displayed on the display of the user terminal of the streamer of fusion streaming.

FIG. 14 A block diagram showing a hardware configuration example of an information processing apparatus.

### DETAILED DESCRIPTION

Hereinafter, the same or equivalent components, members, processes, and signals shown in the drawings are denoted by the same reference numerals, and overlapping descriptions will be omitted as appropriate. Also, some members that are not important for the description are omitted in the drawings.

The live streaming system according to the embodiment supports activities such as daily logs, travel, unboxing, shopping, picnics, and mukbang to diversify V-Liver (Virtual Liver: a streamer who performs live streaming using an avatar instead of themselves) content, and enables the creation of 2.5-dimensional (2.5D) content by integrating avatars or virtual characters into real-world environments. Current V-Liver content is mainly closed within virtual spaces and has weak expansion into the real world, which often becomes a bottleneck in attracting viewers' interest. The live streaming system according to the present embodiment enables a rear camera (also referred to as a back camera) function for capturing real-world scenes and introduces a voice-controlled avatar/character function so that V-Livers can produce more creative and diverse content. This function makes V-Liver live streaming rooms more enjoyable. Additionally, this function realizes a cross-domain between the virtual domain and the real domain. The avatar is displayed in front of a real-world image background. This is a fusion of the real world and the virtual world. This strengthens the emotional connection between the V-Liver and the viewer.

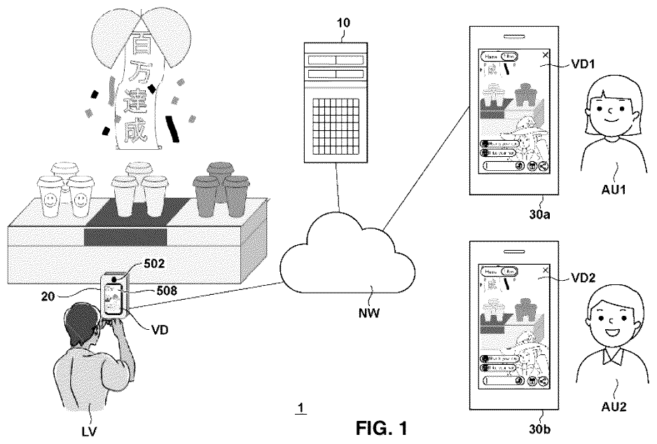

FIG. 1 is a schematic diagram showing the configuration of a live streaming system 1 according to an embodiment of the present disclosure. The live streaming system 1 provides an interactive live streaming service allowing a streamer (also referred to as a Liver or Anchor) LV and viewers (also referred to as Audience) AU (AU1, AU2, . . . ) to interact in real-time. As shown in FIG. 1, the live streaming system 1 includes a server 10, a user terminal 20 on the streamer side, and user terminals 30 (30a, 30b, . . . ) on the viewer side. In addition to the streamer distributing the live stream and the viewers watching the live stream, there are users who have logged into the live streaming platform but are neither streaming nor watching. Such users are referred to as active users. Streamers, viewers, and active users may be collectively referred to as users. The server 10 may be configured by one or a plurality of information processing apparatuses connected to a network NW. The user terminals 20 and 30 may be mobile terminals such as smartphones, tablet-type terminals, laptop PCs, recorders, portable game consoles, or wearable devices, or may be stationary devices such as desktop PCs. The server 10, the user terminal 20, and the user terminals 30 are connected to be communicable with each other via various wired or wireless networks NW.

The live streaming system 1 involves the streamer LV, the viewers AU, and an administrator (not shown) who manages the server 10. The streamer LV is a person who records and films content such as their own singing, talk, performance, fortune-telling, game commentary, daily logs, travel, unboxing, shopping, picnics, mukbang, etc., using their own user terminal 20 and uploads it directly to the server 10 to transmit content in real-time. The administrator provides a platform for live streaming of content on the server 10 and mediates or manages real-time interactions between the streamer LV and the viewers AU. The viewer AU accesses the platform using the user terminal 30, selects desired content, and watches it. During the live streaming of this content, when the viewer AU performs an operation to comment, support, or request fortune-telling via the user terminal 30, and the streamer LV providing the content reacts to such comments, support, or requests, and said reaction is conveyed to the viewer AU via video and/or audio, two-way communication is established.

In this specification, “live streaming” may mean a data transmission mode that realizes a state in which at least a part of the content recorded/filmed by the user terminal 20 of the streamer LV, for example, an image, audio, or both, is reproduced and becomes viewable on the user terminal 30 of the viewer AU substantially in real-time, or may mean the streaming itself realized by such a transmission mode. Live streaming may be realized using existing live streaming technologies such as HTTP Live Streaming, Common Media Application Format, Web Real-Time Communications, Real-Time Messaging Protocol, MPEG DASH, etc. Live streaming includes a transmission mode in which the viewer AU can watch the content with a predetermined delay while the streamer LV is recording/filming the content. Regarding the magnitude of the delay, at least a delay of a magnitude that allows interaction between the streamer LV and the viewer AU to be established is permitted. However, live streaming is distinguished from so-called on-demand streaming in which the entire data of recorded/filmed content is temporarily saved on a server, and the data is provided from the server to a user in response to a request from the user at an arbitrary timing thereafter.

In this specification, “video data” is data including image data (also referred to as video data) generated by the imaging function of the user terminals 20 and 30 and audio data (also referred to as audio data) generated by the audio input function of the user terminals 20 and 30.

In the present embodiment, there are three different streaming types for live streaming: (1) Normal streaming, which streams video data including image data obtained from the front camera of the streamer's user terminal 20 and audio data obtained from the microphone of the user terminal 20 to the viewer's user terminal 30; (2) Virtual streaming, which streams video data including image data representing an image in which an avatar accompanied by movement corresponding to image data obtained from the front camera of the streamer's user terminal 20 is superimposed on a predetermined virtual background, and audio data obtained from the microphone of the user terminal 20, to the viewer's user terminal 30; and (3) Fusion streaming, which streams video data including image data representing an image in which an avatar accompanied by movement corresponding to audio data obtained from the microphone of the streamer's user terminal 20 is superimposed on an image obtained by the rear camera of the user terminal 20, and audio data obtained from the microphone of the user terminal 20, to the viewer's user terminal 30.

In the example of FIG. 1, the streamer LV is performing fusion streaming. The user terminal 20 of the streamer LV generates audio data by recording the voice of the streamer LV who is talking, and also generates image data by filming with a rear camera (not shown in FIG. 1). The user terminal 20 generates video data by combining the audio data and the image data and transmits it to the server 10 via the network NW. In fusion streaming, the streamer LV holds the user terminal 20 while looking at the display 508 of the user terminal 20, that is, such that the front camera 502 faces the streamer LV. In fusion streaming, since the front camera 502 is turned off, it is assumed that the image of the streamer LV is not recorded. The streamer LV images a desired subject by pointing the rear camera of the user terminal 20 at that subject. In fusion streaming, the avatar of the streamer LV with the image of the rear camera as the background image is streamed to the viewer.

The user terminals 30a and 30b of the viewers AU1 and AU2 who have requested the platform to view the fusion streaming of the streamer LV receive the video data related to the fusion streaming via the network NW, respectively, and by reproducing the received video data, display moving images VD1 and VD2 on the displays and output audio from speakers. The moving images VD1 and VD2 displayed on the respective user terminals 30a and 30b are substantially identical to the moving image VD displayed by the user terminal 20 of the streamer LV reproducing the video data similarly received from the server 10. By displaying the moving image VD on the display 508 of the user terminal 20, it becomes possible for the streamer LV to confirm the content of the streaming.

The recording/filming at the user terminal 20 of the streamer LV and the reproduction of the video data at the user terminals 30a and 30b of the viewers AU1 and AU2 are performed substantially simultaneously. When one viewer AU1 inputs a comment regarding the content of the streamer LV's talk into the user terminal 30a, the server 10 causes the comment to be displayed on the user terminal 20 of the streamer LV in real-time and also on the user terminals 30a and 30b of the respective viewers AU1 and AU2. When the streamer LV who reads the comment develops talk covering that content, the movement of the avatar and the voice of the talk corresponding to that talk are output at the user terminals 30a and 30b of the respective viewers AU1 and AU2, and thereby it is recognized that a conversation between the streamer LV (their avatar) and the viewer AU1 has been established. In this way, in the live streaming system 1, live streaming enabling interactive two-way communication is realized.

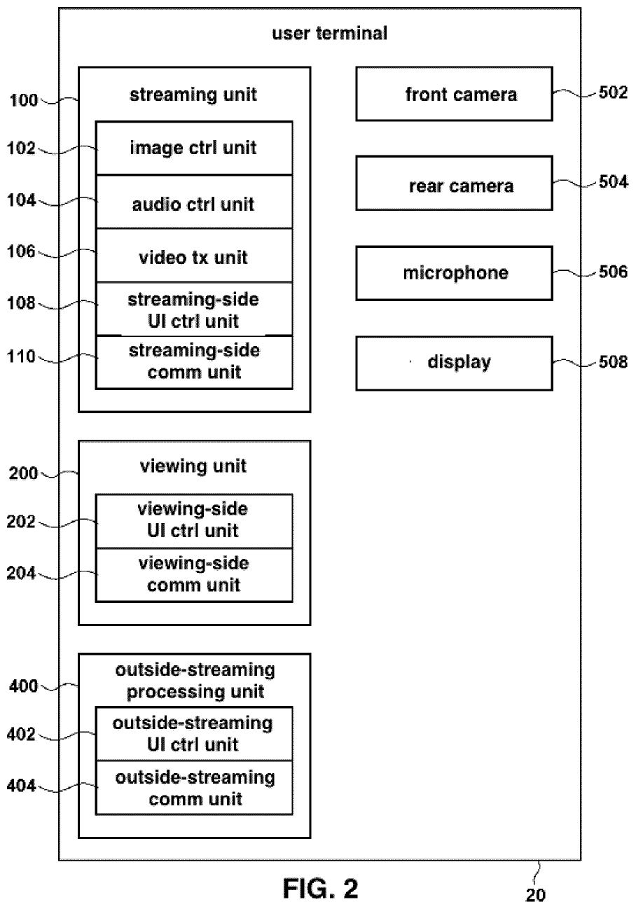

FIG. 2 is a block diagram showing the function and configuration of the user terminal 20 in FIG. 1. The user terminal 30 has similar functions and configurations to the user terminal 20. Each block shown in FIG. 2 and subsequent block diagrams can be realized in terms of hardware by elements such as a CPU of a computer or mechanical devices, and in terms of software by a computer program or the like, but here, functional blocks realized by their cooperation are depicted. Therefore, it is understood by those skilled in the art who have access to this specification that these functional blocks can be realized in various forms by a combination of hardware and software.

The streamer LV and the viewer AU download and install a live streaming application program (hereinafter referred to as a live streaming app) according to the present embodiment onto the user terminals 20 and 30 from a download site via the network NW. Alternatively, the live streaming app may be pre-installed on the user terminals 20 and 30. By the live streaming app being executed by the user terminals 20 and 30, the user terminals 20 and 30 communicate with the server 10 via the network NW and realize various functions. Hereinafter, functions realized by the user terminals 20 and 30 (processors such as CPUs thereof) executing the live streaming app will be described as functions of the user terminals 20 and 30. These functions are actually functions that the live streaming app causes the user terminals 20 and 30 to realize. In other embodiments, these functions may be realized by a computer program described in a programming language such as HTML (HyperText Markup Language), which is transmitted from the server 10 to web browsers of the user terminals 20 and 30 via the network NW and executed by the web browsers.

The user terminal 20 comprises: a streaming unit 100 that generates video data recording images and audio and provides it to the server 10; a viewing unit 200 that obtains video data from the server 10 and reproduces it; an outside-streaming processing unit 400 that processes requests by active users; a front camera 502; a rear camera 504; a microphone 506; and a display 508. A user activates the streaming unit 100 when performing streaming, the viewing unit 200 when performing viewing, and the outside-streaming processing unit 400 when searching for a live stream to watch, viewing a streamer's profile, or watching an archive. A user terminal where the streaming unit 100 is active is a streamer side, i.e., a user terminal generating video data, a user terminal where the viewing unit 200 is active is a viewer side, i.e., a user terminal reproducing video data, and a user terminal where the outside-streaming processing unit 400 is active is a user terminal of an active user. In the present embodiment, a case where the user terminal 20 is a smartphone comprising a rear camera and a front camera will be described, but the present invention is not limited to this, and it is apparent to those skilled in the art who have access to this specification that the technical idea according to the present embodiment can be applied to any terminal comprising a camera and a microphone.

The rear camera refers to a camera installed on the back of a mobile phone, smartphone, or tablet terminal. It is installed on the side without the display, faces the back toward the subject, and can capture the projected screen. It is also called a back camera or out-camera. In contrast to the rear camera, a camera installed on the display side of the terminal is called an in-camera or front camera. Generally, the rear camera captures landscapes or other people, whereas the front camera is often used for capturing oneself or for video calls.

The streaming unit 100 includes an imaging control unit 102, an audio control unit 104, a video transmission unit 106, a streaming-side UI control unit 108, and a streaming-side communication unit 110. The imaging control unit 102 is connected to the front camera 502 and the rear camera 504 and controls imaging by those cameras. The imaging control unit 102 obtains image data from the front camera 502 in normal streaming and virtual streaming. The imaging control unit 102 obtains image data from the rear camera 504 in fusion streaming. The audio control unit 104 is connected to the microphone 506 and controls audio input by the microphone 506. The audio control unit 104 obtains audio data from the microphone 506. The video transmission unit 106 transmits video data including the image data obtained by the imaging control unit 102 and the audio data obtained by the audio control unit 104 to the server 10 via the network NW. The transmission of video data by the video transmission unit 106 is performed in real-time. That is, the generation of video data by the imaging control unit 102 and the audio control unit 104 and the transmission of the generated video data by the video transmission unit 106 are performed substantially simultaneously.

The streaming-side UI control unit 108 controls the UI for the streamer. The streaming-side UI control unit 108 is connected to the display 508 and causes the display to display a moving image by reproducing video data. In normal streaming, the streaming-side UI control unit 108 causes the display 508 to display a moving image by reproducing video data targeted for transmission by the video transmission unit 106. In virtual streaming and fusion streaming, the streaming-side UI control unit 108 causes the display 508 to display a moving image by reproducing video data received from the server 10 by the streaming-side communication unit 110. The streaming-side UI control unit 108 is connected to input means (not shown in FIG. 2) such as a touch panel, keyboard, and display, and obtains input from the streamer via these input means. The streaming-side UI control unit 108 superimposes a predetermined frame image on the moving image. The frame image includes various user interface objects (hereinafter simply referred to as objects) for accepting input from the streamer, comments input by viewers, and information obtained from the server 10. The streaming-side UI control unit 108 accepts, for example, tap input on an object by the streamer.

The streaming-side communication unit 110 controls communication with the server 10 during live streaming. The streaming-side communication unit 110 transmits the content of the input by the streamer obtained by the streaming-side UI control unit 108 to the server 10 via the network NW. The streaming-side communication unit 110 receives various information associated with the live streaming from the server 10 via the network NW.

The viewing unit 200 includes a viewing-side UI control unit 202 and a viewing-side communication unit 204. The viewing-side communication unit 204 controls communication with the server 10 during live streaming. The viewing-side communication unit 204 receives video data related to a live stream in which a streamer and a viewer participate from the server 10 via the network NW.

The viewing-side UI control unit 202 controls the UI for the viewer. The viewing-side UI control unit 202 is connected to the display 508 and a speaker (not shown), and by reproducing the received video data, causes the display 508 to display a moving image and causes the speaker to output audio. Outputting an image to the display 508 and outputting audio from the speaker can be collectively referred to as “video data being reproduced”. The viewing-side UI control unit 202 is connected to input means such as a touch panel and keyboard (not shown in FIG. 2) and obtains input from the viewer via these input means. The viewing-side UI control unit 202 superimposes a predetermined frame image on the image of the video data obtained from the server 10. The frame image includes various objects for accepting input from the viewer, comments input by the viewer, and information obtained from the server 10. The viewing-side communication unit 204 transmits the content of the input by the viewer obtained by the viewing-side UI control unit 202 to the server 10 via the network NW.

The outside-streaming processing unit 400 includes an outside-streaming UI control unit 402 and an outside-streaming communication unit 404. The outside-streaming UI control unit 402 controls the UI for active users. For example, the outside-streaming UI control unit 402 generates a live streaming selection screen that displays a list of currently joinable live streams and accepts the selection of a live stream by an active user, and causes the display to display it. The outside-streaming UI control unit 402 generates a profile screen of an arbitrary user and causes the display to display it. The outside-streaming UI control unit 402 reproduces an archive generated by recording/filming past live streams.

The outside-streaming communication unit 404 controls communication with the server 10 outside of live streaming. The outside-streaming communication unit 404 receives information for generating the live streaming selection screen, information for generating the profile screen, and archive data from the server 10 via the network NW. The outside-streaming communication unit 404 transmits the content of input by the active user to the server 10 via the network NW.

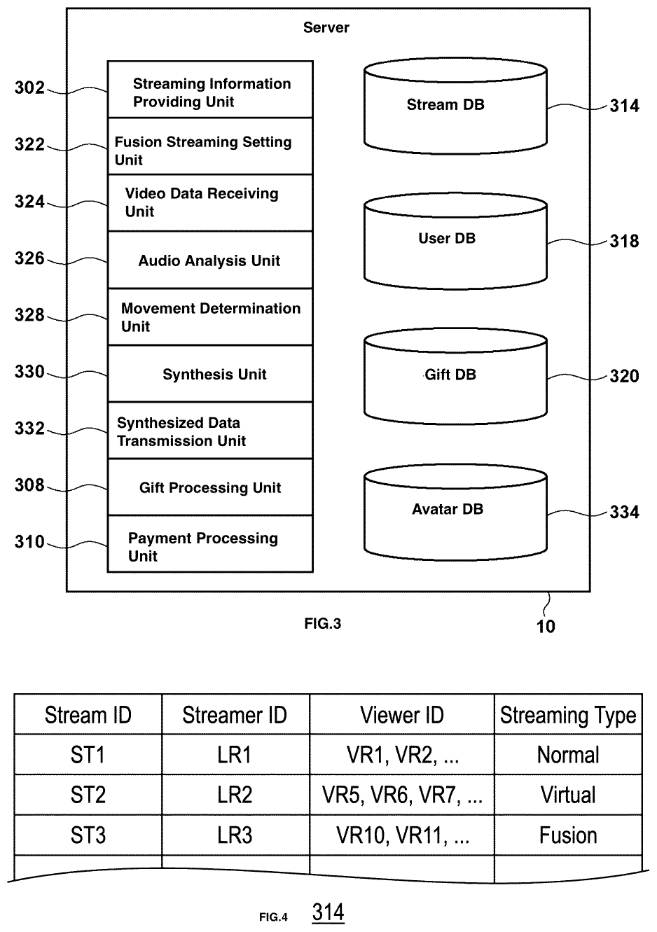

FIG. 3 is a block diagram showing the function and configuration of the server 10 in FIG. 1. The server 10 comprises a streaming information providing unit 302, a gift processing unit 308, a payment processing unit 310, a stream DB 314, a user DB 318, a gift DB 320, a fusion streaming setting unit 322, a video data receiving unit 324, an audio analysis unit 326, a movement determination unit 328, a synthesis unit 330, a synthesized data transmission unit 332, and an avatar DB 334.

FIG. 4 is a data structure diagram showing an example of the Stream DB 314 in FIG. 3. The Stream DB 314 holds information on currently ongoing live streams. The Stream DB 314 holds a Stream ID identifying a live stream on the live streaming platform provided by the live streaming system 1, a Streamer ID which is a User ID identifying the streamer of said live stream, Viewer IDs which are User IDs identifying viewers of said live stream, and the streaming type of said live stream, in association with each other.

In the live streaming platform provided by the live streaming system 1 according to the present embodiment, when a user performs live streaming, that user becomes a streamer, and when the same user watches a live stream streamed by another user, they become a viewer. Therefore, the distinction between streamer and viewer is not fixed, and a User ID registered as a Streamer ID at one time may be registered as a Viewer ID at another timing.

The streaming type of live streaming is one of normal streaming, virtual streaming, and fusion streaming. A streamer can specify the streaming type when starting a live stream or can change the streaming type while performing a live stream. Hereinafter, a case where the streamer performs fusion streaming will be described.

FIG. 5 is a data structure diagram showing an example of the User DB 318 in FIG. 3. The User DB 318 holds information regarding users. The User DB 318 holds a User ID identifying a user, points held by said user, and remuneration granted to said user, in association with each other.

Points are electronic value that circulates within the live streaming platform. Users purchase points via credit cards or other settlement means. Remuneration is electronic value defined within the live streaming platform and is an index for determining the amount of money a streamer receives from the administrator of the live streaming platform. On the live streaming platform, when a viewer sends a gift to a streamer within a live stream or outside of a live stream, the viewer's points are consumed, and the streamer's remuneration increases by a corresponding amount.

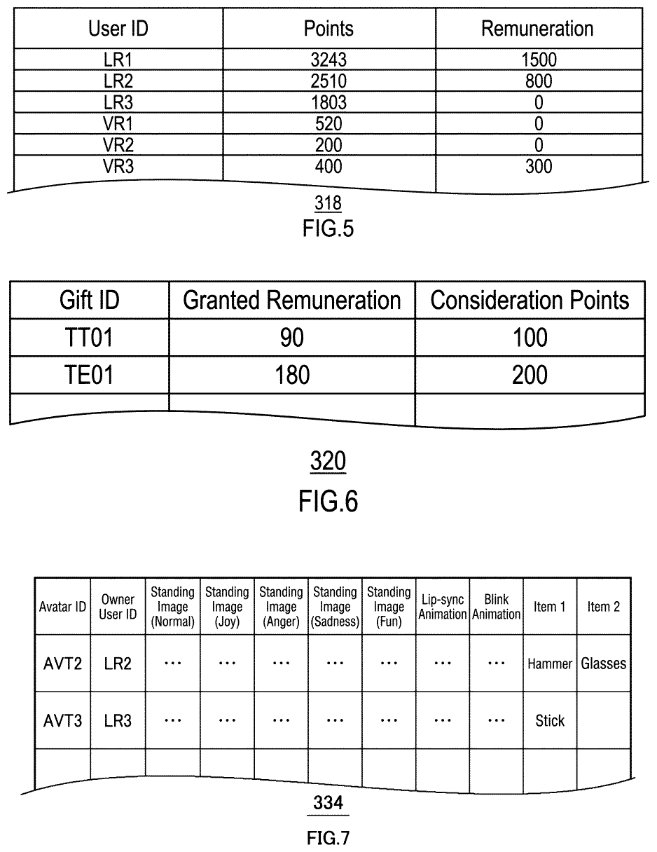

FIG. 6 is a data structure diagram showing an example of the Gift DB 320 in FIG. 3. The Gift DB 320 holds information regarding gifts usable by viewers in live streaming. A gift is electronic data or a digital item having the following characteristics:
Can be purchased using points or money as consideration, or granted for free.
Something a viewer can send to a streamer. Sending a gift to a streamer is also referred to as using a gift or “throwing” a gift.
There are types where the purchase and use of the gift occur simultaneously as a set, and types where the viewer can use it at an arbitrary timing after purchase.
When a viewer sends a gift to a streamer, corresponding remuneration is granted to that streamer.
When a gift is used, an effect associated with the gift may occur. For example, an effect corresponding to the gift appears on the live streaming room screen.

The Gift DB 320 holds a Gift ID identifying a gift, granted remuneration which is remuneration granted to a streamer when said gift is sent to the streamer, and consideration points which are consideration to be paid when using said gift, in association with each other. A viewer can send said gift to a streamer by paying the consideration points of the desired gift during viewing of a live stream. Payment of these consideration points may be performed by appropriate electronic settlement means, for example, by the viewer paying the consideration points to the administrator. Alternatively, payment by bank transfer or credit card may be used. The relationship between the granted remuneration and the consideration points can be arbitrarily set by the administrator. For example, it may be set such that Granted Remuneration=Consideration Points. Alternatively, points obtained by multiplying the granted remuneration by a predetermined coefficient such as 1.2 may be set as the consideration points, or points obtained by adding predetermined fee points to the granted remuneration may be set as the consideration points.

FIG. 7 is a data structure diagram showing an example of the Avatar DB 334 in FIG. 3. The Avatar DB 334 holds information on the streamer's avatar. The streamer generates an avatar in advance on their own terminal or the like and uploads the data of the generated avatar to the live streaming platform. The server 10 registers the data of the avatar uploaded in such a way in the Avatar DB 334. The Avatar DB 334 holds an Avatar ID identifying the avatar, an Owner User ID identifying the owner of the avatar, data of a standing illustration (portrait) image of the avatar in a normal state, data of a standing illustration image of the avatar in a happy state, data of a standing illustration image of the avatar in an angry state, data of a standing illustration image of the avatar in a sad state, data of a standing illustration image of the avatar in a fun state, data of an animation expressing lip-syncing of the avatar, data of an animation expressing blinking of the avatar, and items granted to the avatar, in association with each other. In the live streaming platform, viewers can send items to the streamer's avatar. This may be realized by using a gift associated with an item during live streaming, or by a viewer purchasing an item outside of live streaming and sending it to the streamer. Alternatively, the streamer may purchase an item and grant it to their own avatar. Technology for enabling giving digital items to a virtual streamer is known, so it will not be described in detail here.

Returning to FIG. 3, when the fusion streaming setting unit 322 receives a fusion streaming start request for starting fusion streaming from the user terminal 20 of the streamer via the network NW, it registers a Stream ID identifying said fusion streaming and the Streamer ID of the streamer of said fusion streaming in the Stream DB 314. Simultaneously, the fusion streaming setting unit 322 transmits a deactivation instruction for deactivating the front camera to the user terminal 20 of the requesting streamer via the network NW. Upon receiving the deactivation instruction, the streaming-side communication unit 110 of the user terminal 20 deactivates the front camera. For example, it may disable the front camera, turn off the front camera, or ignore data from the front camera. When the fusion streaming setting unit 322 receives a fusion streaming end request for ending fusion streaming from the user terminal 20 of the streamer via the network NW, it deletes the information of said fusion streaming from the Stream DB 314 and simultaneously transmits a release instruction for releasing the deactivation of the front camera to the user terminal 20 of the requesting streamer via the network NW. In this way, the fusion streaming setting unit 322 functions as means for deactivating the front camera of the streamer's user terminal 20 during fusion streaming.

When the fusion streaming setting unit 322 receives a fusion streaming switching request for switching from another streaming mode, i.e., virtual streaming or normal streaming, to fusion streaming from the user terminal 20 of the streamer via the network NW, it updates the Stream DB 314 so that the streaming type corresponding to the Streamer ID of said streamer becomes fusion streaming. Simultaneously, the fusion streaming setting unit 322 transmits a deactivation instruction for deactivating the front camera to the user terminal 20 of the requesting streamer via the network NW.

When the streaming information providing unit 302 receives a request for providing information related to live streaming from the outside-streaming communication unit 404 of an active user's user terminal via the network NW, it refers to the Stream DB 314 to generate a list of currently viewable live streams. The streaming information providing unit 302 transmits the generated list to the requesting user terminal via the network NW. The outside-streaming UI control unit 402 of the requesting user terminal generates a live streaming selection screen based on the received list and causes the display of the user terminal to display it.

When the outside-streaming UI control unit 402 of the user terminal accepts the selection of fusion streaming by the active user on the live streaming selection screen, it generates a streaming request including the Stream ID of the selected fusion streaming and transmits it to the server 10 via the network NW. The streaming information providing unit 302 starts providing the fusion streaming identified by the Stream ID included in the received streaming request to the requesting user terminal. The streaming information providing unit 302 updates the Stream DB 314 so that the User ID of the active user of the requesting user terminal is included in the Viewer IDs of said Stream ID. Thereby, the active user becomes a viewer of the selected fusion streaming.

The video data receiving unit 324 receives, while fusion streaming is being performed, video data including image data obtained from the rear camera of the user terminal 20 of the streamer of said fusion streaming and audio data obtained from the microphone of said user terminal 20 from said user terminal 20 via the network NW.

The audio analysis unit 326 analyzes the audio data of the fusion streaming received by the video data receiving unit 324. The movement determination unit 328 determines the movement of the avatar of the streamer of the fusion streaming based on the analysis result of the audio data by the audio analysis unit 326. In the present embodiment, there are the following four modes for avatar voice control, and the configuration is such that the streamer and/or the administrator can appropriately select any one of these modes or voice control off. For example, the mode may be selected by the administrator and be unchangeable, or may be selectable by the streamer each time. Note that the present disclosure is not limited to these four modes, and other methods, modes, algorithms, etc., for determining the movement of the streamer's avatar based on the obtained audio data may be used.

### (1) Volume Control Mode

In the volume control mode, the movement determination unit 328 determines the movement of the avatar of the streamer of said fusion streaming based on the volume of the audio represented by the audio data of the fusion streaming received by the video data receiving unit 324. For example, the audio analysis unit 326 measures the volume of the audio represented by the audio data of the fusion streaming received by the video data receiving unit 324. The movement determination unit 328 changes the display mode of the mouth of the avatar when the volume measured by the audio analysis unit 326 exceeds a threshold value. When the volume M exceeds a start threshold Ms (e.g., 60 dB, 70 dB, 100 dB, etc.), the movement determination unit 328 determines to start the avatar's lip-sync animation. When the volume M falls below an end threshold Me, the movement determination unit 328 determines to stop the avatar's lip-sync animation. Fluttering of animation on/off may be suppressed by setting Ms>Me. Thereby, the avatar's mouth maintains a closed state or a state with no movement when the streamer is not speaking, and the avatar's lip-sync starts in conjunction with the streamer starting to speak, so a more natural avatar operation can be realized.

Alternatively, in addition to or instead of the lip-sync animation, a series of mouth images with different degrees of mouth opening/closing may be registered in the Avatar DB 334, and the movement determination unit 328 may select a mouth image with an opening/closing degree corresponding to the volume measured by the audio analysis unit 326 from among the series of mouth images. For example, the Avatar DB 334 may hold a mouth image with 0% opening/closing degree (mouth completely closed state) corresponding to volume 0 dB, a mouth image with 20% opening/closing degree corresponding to volume 20 dB, a mouth image with 50% opening/closing degree corresponding to volume 50 dB, and a mouth image with 100% opening/closing degree (mouth completely open state) corresponding to volume 100 dB, in association with the Avatar ID. If the measured volume is 20 dB, the movement determination unit 328 selects the mouth image with 20% opening/closing degree.

In this example, control based on volume has been described, but the invention is not limited to this, and the movement of the avatar may be determined based on other parameters of audio, for example, pitch or tone. In this case, for example, when a tone pattern and/or pitch pattern corresponding to a specific emotion is detected, the movement determination unit 328 may determine to switch the avatar's standing illustration to a standing illustration of the corresponding emotion.

In this example, control of the mouth image based on volume has been described, but the invention is not limited to this, and other parts of the avatar, for example, images of eyes or head, may be controlled by volume. In this case, for example, the number of blinks may be increased (the execution frequency of blink animation is increased) as the volume increases or the pitch becomes higher, or the head may be made to bow as the volume decreases. Thereby, more natural movements can be dynamically generated.

### (2) ML (Machine Learning) Model Utilization Context Adaptive Mode

In the ML model utilization context adaptive mode, the movement determination unit 328 determines the movement of the avatar of the streamer of said fusion streaming according to the context of the conversation in the fusion streaming obtained by analyzing the content of the audio represented by the audio data of the fusion streaming received by the video data receiving unit 324 and/or comments posted by viewers in the fusion streaming and/or events being held. In this example, the movement determination unit 328 utilizes the output of a pre-trained context ML model that takes audio data and comments as input and outputs a category of the conversation context. Such a context ML model may be realized using known supervised machine learning technologies such as GPT (Generative Pre-trained Transformer)-3, GPT-3.5, GPT-4 provided by openAI, LLaMA (Large Language Model Meta AI) provided by Meta, Bloom (BigScience Language Open-science Open-access Multilingual), etc. The server 10 may include the context ML model, or a context ML model built in an external service may be used via an API (Application Programming Interface). Categories of conversation context are, for example, baseball, soccer, elections, specific idols, specific cuisine, recent news, specific events being held on the live streaming platform, etc.

The audio analysis unit 326 inputs the audio data of the fusion streaming received by the video data receiving unit 324 and comments posted by viewers in said fusion streaming into the context ML model. The audio analysis unit 326 obtains the category of the conversation context output by the context ML model in response to said input. The movement determination unit 328 selects the avatar's standing illustration and/or animation and/or item corresponding to the category obtained by the audio analysis unit 326. For example, if the category is baseball and a bat item has been granted to the avatar, the movement determination unit 328 determines to make the avatar hold the bat item. Also, if the category is explanation and a glasses item of the avatar has been granted, the movement determination unit 328 determines to apply the glasses item to the avatar's face.

In this example, a case of selecting an item according to a category has been described, but the invention is not limited to this, and for example, the avatar's pose or size may be changed according to the category.

### (3) ML Model Utilization Emotion Adaptive Mode

In the ML model utilization emotion adaptive mode, the movement determination unit 328 determines the movement of the avatar of the streamer of said fusion streaming according to the emotion of the streamer of said fusion streaming obtained by analyzing the content of the audio represented by the audio data of the fusion streaming received by the video data receiving unit 324 and/or comments posted by viewers in the fusion streaming and/or events being held. In this example, the movement determination unit 328 utilizes the output of a pre-trained emotion ML model that takes audio data as input and outputs a type of emotion. Such an emotion ML model may be realized using known supervised machine learning technologies such as GPT-3, GPT-3.5, GPT-4 provided by openAI, LLaMA provided by Meta, Bloom, etc. The server 10 may include the emotion ML model, or an emotion ML model built in an external service may be used via an API. Types of emotion are, for example, joy, anger, sadness, fun, etc.

The audio analysis unit 326 inputs the audio data of the fusion streaming received by the video data receiving unit 324 into the emotion ML model. The audio analysis unit 326 obtains the type of the streamer's emotion output by the emotion ML model in response to said input. The movement determination unit 328 selects the avatar's standing illustration and/or animation and/or item corresponding to the type of emotion obtained by the audio analysis unit 326. For example, when the type of emotion is anger, the movement determination unit 328 may determine to switch the avatar's standing illustration to a standing illustration in an angry state.

In this example, a case of selecting a standing illustration according to emotion has been described, but the invention is not limited to this, and for example, the avatar's items or size may be changed according to emotion.

In the examples of (2) and (3), cases of using an ML model that outputs a category or emotion type have been described, but the invention is not limited to this, and for example, an ML model that takes audio data as input and outputs a designation of a standing illustration and/or animation and/or item may be used. In this case, the ML model predicts an appropriate avatar movement or reaction according to the conversation context or the streamer's emotion.

### (4) Voice Command Detection Mode

In the voice command detection mode, when a predetermined command is detected in the audio data of the fusion streaming received by the video data receiving unit 324, the movement determination unit 328 determines the movement of the avatar of the streamer of said fusion streaming corresponding to said command. For example, the audio analysis unit 326 monitors the audio data of the fusion streaming received by the video data receiving unit 324 and attempts to detect a command. A command is a character string associated with a specific movement of the avatar and is registered in advance by the administrator. Examples of commands are “turn left”, “turn right”, “nod”, “wave hand”, etc.

When the audio analysis unit 326 detects a command, the movement determination unit 328 determines the movement of the avatar corresponding to the detected command. For example, when the command “nod” is detected (that is, when the streamer says “nod”), the movement determination unit 328 selects an animation expressing the avatar's nod. When a command is detected within the streamer's audio, the audio portion corresponding to the detected command may not be transmitted to the viewer's user terminal, preventing the command from being output as audio on the viewer's user terminal.

Alternatively, in the voice command detection mode, the movement determination unit 328 may utilize the output of a pre-trained command detection ML model that takes audio data as input and outputs a detected command. Such a command detection ML model may be realized using known supervised machine learning technologies such as GPT-3, GPT-3.5, GPT-4 provided by openAI, LLaMA provided by Meta, Bloom, etc. The audio analysis unit 326 inputs the audio data of the fusion streaming received by the video data receiving unit 324 into the command detection ML model. The audio analysis unit 326 obtains the detected command output by the command detection ML model in response to said input. The movement determination unit 328 determines the movement of the avatar corresponding to the command obtained by the audio analysis unit 326. For example, when the streamer says “Uh-huh” and the command detection ML model detects the command “nod” in response to the input of that utterance, the movement determination unit 328 selects an animation expressing a nod according to said detection result. In this case, the audio is streamed to the viewer as is without partial deletion. Since the streamer simply speaks normally without being conscious of what the command is and the ML model automatically detects the appropriate command from the voice, and since the command part is not deleted from the audio, more natural fusion streaming can be realized.

In any of the modes (1) to (4), the movement determination unit 328 determines the movement of the avatar without using information obtained by the front camera. In this example, the server 10 realizes this by causing the front camera to be turned off during fusion streaming, but in other embodiments, the server may determine the movement of the avatar without using information obtained by the front camera by other methods such as ignoring or discarding image data from the front camera.

The synthesis unit 330 synthesizes the image data and the avatar data to generate synthesized data such that the avatar is superimposed on the image represented by the image data of the fusion streaming received by the video data receiving unit 324 (image from the rear camera), and said avatar realizes the movement determined by the movement determination unit 328. The synthesis of images in the synthesis unit 330 may be realized using known VR (Virtual Reality) technology or AR (Augmented Reality) technology.

The synthesized data transmission unit 332 transmits the synthesized data obtained as a result of the synthesis by the synthesis unit 330 to the user terminal of the viewer of the fusion streaming via the network NW. Simultaneously, the synthesized data transmission unit 332 transmits said synthesized data to the user terminal of the streamer of the fusion streaming via the network NW.

The synthesized data transmission unit 332 receives a signal indicating user input by the viewer during fusion streaming, i.e., during reproduction of synthesized data, from the viewing-side communication unit 204. The signal indicating user input may be an object designation signal indicating the designation of an object displayed on the display of the user terminal 30, and said object designation signal includes the Viewer ID of the viewer, the Streamer ID of the streamer performing the fusion streaming being watched by the viewer, and an Object ID identifying the object. When the object is a gift icon, the Object ID becomes a Gift ID. The object designation signal in that case becomes a gift use signal indicating the use of a gift for the streamer by the viewer. Similarly, the synthesized data transmission unit 332 receives a signal indicating user input by the streamer during reproduction of video data, for example, an object designation signal, from the streaming-side communication unit 110 of the streaming unit 100 of the user terminal 20.

The gift processing unit 308 updates the User DB 318 to increase the streamer's remuneration according to the granted remuneration of the gift identified by the Gift ID included in the gift use signal. The gift processing unit 308 refers to the Gift DB 320 and identifies the granted remuneration corresponding to the Gift ID included in the received gift use signal. The gift processing unit 308 updates the User DB 318 to add the identified granted remuneration to the remuneration corresponding to the Streamer ID included in the gift use signal.

The payment processing unit 310 processes the payment of consideration for the gift by the viewer in response to the reception of the gift use signal. The payment processing unit 310 refers to the Gift DB 320 and identifies the consideration points of the gift identified by the Gift ID included in the gift use signal. The payment processing unit 310 updates the User DB 318 to deduct the identified consideration points from the points of the viewer identified by the Viewer ID included in the gift use signal.

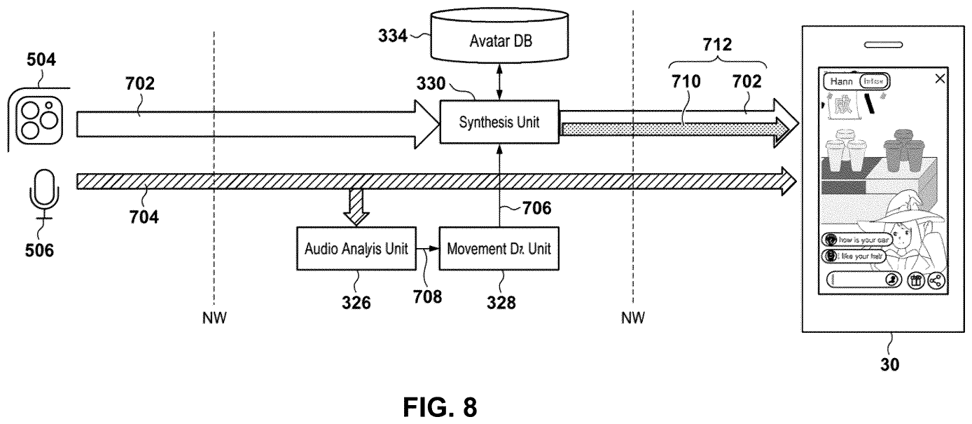

FIG. 8 is a schematic diagram for explaining data processing in fusion streaming. The rear camera 504 of the streamer's user terminal 20 generates image data 702, and the microphone 506 generates audio data 704. These data 702 and 704 are transmitted to the server 10 via the network NW. The audio analysis unit 326 receives the audio data 704, analyzes it, and passes analysis results (volume, content category, emotion, command, etc.) 708 to the movement determination unit 328. The movement determination unit 328 determines movement 706 of the streamer's avatar based on the analysis results 708. The synthesis unit 330 generates synthesized data 712 representing a synthesized image in which an avatar 710 performing the determined movement 706 is superimposed on a background which is the image represented by the image data 702. Data of the avatar 710 is obtained by referring to the Avatar DB 334. The synthesized data transmission unit 332 transmits the synthesized data 712 to each viewer's user terminal 30 via the network NW.

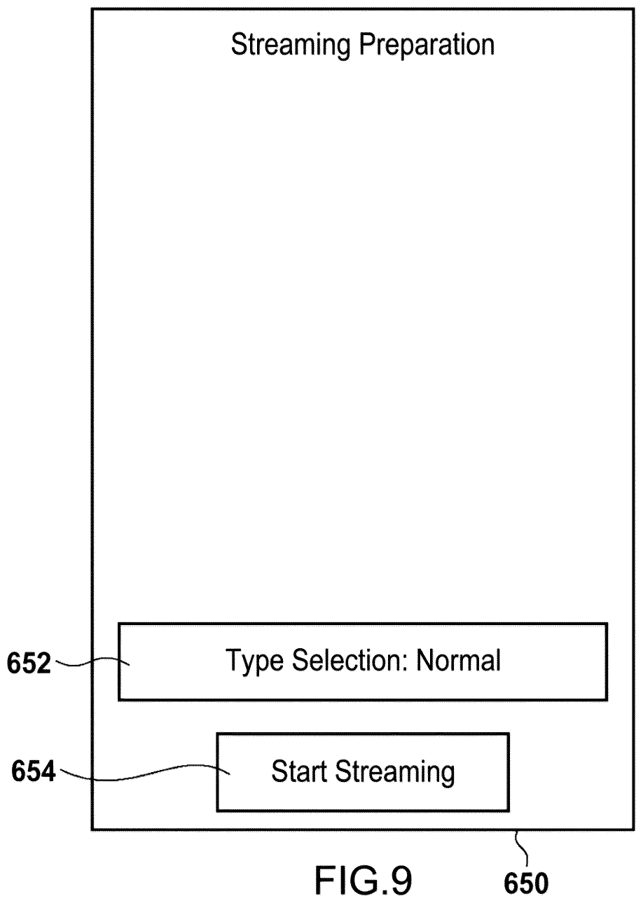

FIG. 9 is a representative screen diagram of a streaming preparation screen 650 displayed on the display of the user terminal 20 of a streamer who is about to start fusion streaming. The streaming preparation screen 650 has a type display area 652 displaying the currently selected streaming type and a start streaming button 654. The streamer taps the type display area 652 to select a streaming type. When the streaming-side UI control unit 108 detects a tap on the type display area 652, it causes the streaming preparation screen 650 to display three objects 656, 658, and 660, each selectable by tapping.

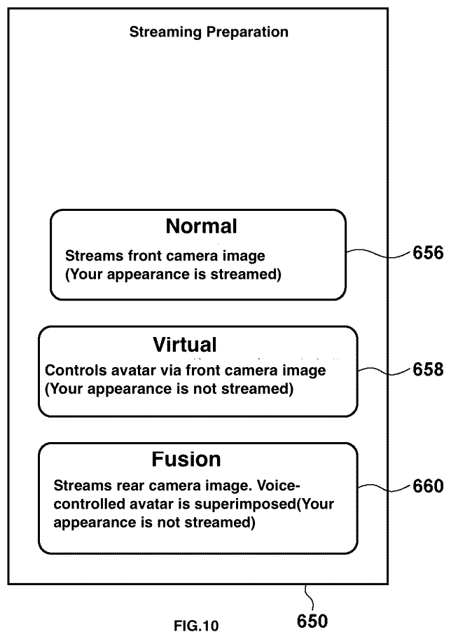

FIG. 10 is a representative screen diagram of the streaming preparation screen 650 displaying three selectable objects. The first object 656 corresponds to normal streaming, the second object 658 corresponds to virtual streaming, and the third object 660 corresponds to fusion streaming. The streamer taps the third object 660 corresponding to the desired fusion streaming.

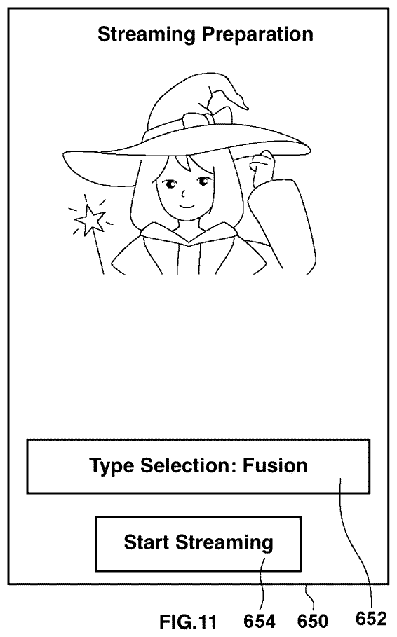

FIG. 11 is a representative screen diagram of the streaming preparation screen 650 displayed on the display of the user terminal 20 of the streamer. FIG. 11 corresponds to the state after the third object 660 is tapped in FIG. 10. The type display area 652 in FIG. 11 indicates that the currently selected streaming type is fusion streaming. When the streamer taps the start streaming button 654 in this state, the streaming-side communication unit 110 generates a fusion streaming start request and transmits it to the server 10 via the network NW.

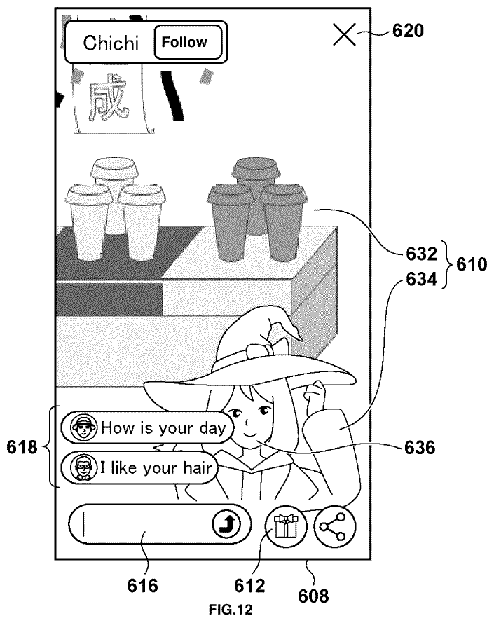

FIG. 12 is a representative screen diagram of a live streaming room screen 608 displayed on the display of the user terminal 30 of a viewer of fusion streaming. The live streaming room screen 608 displays an image obtained by reproducing synthesized data received from the server 10. The live streaming room screen 608 has a moving image 610 obtained by reproducing synthesized data received from the server 10, a gift object 612, a comment input area 616, a comment display area 618, and an end viewing button 620. The viewing-side UI control unit 202 generates the live streaming room screen 608 by superimposing and displaying other objects, i.e., the gift object 612, the comment input area 616, the comment display area 618, and the end viewing button 620, on the moving image 610 obtained by reproducing the synthesized data.

The moving image 610 includes a background image 632 and an avatar 634. The background image 632 is an image captured by the rear camera 504 of the streamer's user terminal 20. The avatar 634 performs movements according to audio. For example, while the streamer is speaking, a mouth portion 636 opens and closes, and while silent, the mouth portion 636 is maintained in a closed state.

The comment display area 618 can include comments input by the viewer, comments input by other viewers, and notifications from the system. Notifications from the system can include information indicating who sent which gift to the streamer. The viewing-side UI control unit 202 generates the comment display area 618 including comments of other viewers and notifications from the system received from the server 10, and includes the generated comment display area 618 in the live streaming room screen 608.

The comment input area 616 accepts input of comments by the viewer. The viewing-side communication unit 204 generates a comment input signal including the comment input in the comment input area 616 and transmits it to the server 10 via the network NW. Simultaneously, the viewing-side UI control unit 202 updates the comment display area 618 so as to display the comment input in the comment input area 616.

The end viewing button 620 is an object for accepting an instruction from the viewer to stop viewing the fusion streaming.

The gift object 612 is an object for accepting use of a gift by the viewer. When the gift object 612 is tapped, a popup for selecting a gift to use is displayed.

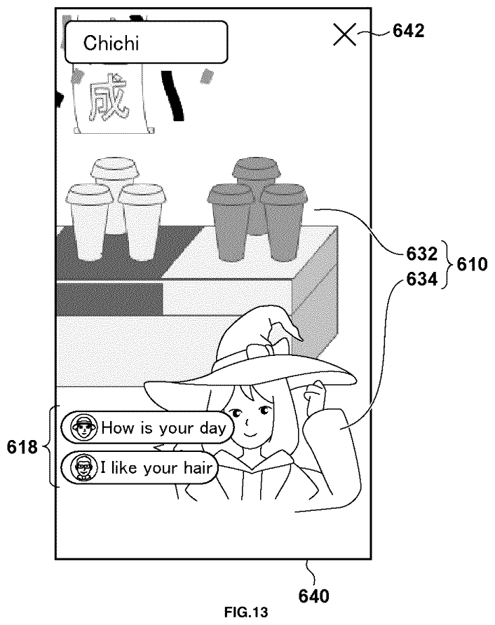

FIG. 13 is a representative screen diagram of a live streaming room screen 640 displayed on the display of the user terminal 20 of the streamer of fusion streaming. The live streaming room screen 640 has the moving image 610 obtained by reproducing synthesized data received from the server 10, the comment display area 618, and an end streaming button 642. The streaming-side UI control unit 108 generates the live streaming room screen 640 by superimposing and displaying other objects, i.e., the comment display area 618 and the end streaming button 642, on the moving image 610 obtained by reproducing the synthesized data.

The end streaming button 642 is an object for accepting an instruction from the streamer to stop the fusion streaming. When the streamer taps the end streaming button 642, the streaming-side communication unit 110 generates a fusion streaming end request and transmits it to the server 10 via the network NW.

In the above-described embodiment, examples of databases are hard disks and semiconductor memories. Also, it is understood by those skilled in the art who have access to this specification, based on the description of this specification, that each part can be realized by a CPU (not shown), modules of installed application programs, modules of system programs, semiconductor memory temporarily storing the contents of data read from a hard disk, etc.

According to the live streaming system 1 related to the present embodiment, since the movement of the avatar during fusion streaming is controlled based on audio, data from the front camera becomes unnecessary. In mobile terminals comprising a front camera and a rear camera such as smartphones, activating those two cameras simultaneously is usually not technically supported. In the present embodiment, such technical constraints are overcome by realizing avatar control that does not rely on the front camera. Since V-Livers can perform fusion streaming more easily, the breadth of streaming expands, making it easier to attract viewers.

In addition, deactivating the front camera during fusion streaming also provides the following operational effects. V-Livers are usually not allowed to show their faces, and it must be avoided that their face is streamed even if by accident or for a moment. In the fusion streaming according to the present embodiment, since the front camera is turned off in the first place, the risk of the V-Liver's face being exposed due to accident or operation error can be suppressed or eliminated.

Also, in the live streaming system 1 according to the present embodiment, for example, when using an ML model or using audio parameter control, there is no need to ask the streamer for special consideration to realize voice control of the avatar, or even if there is, the degree thereof is minor. The voice control according to the present embodiment is unlikely to hinder or disturb fusion streaming. The streamer can freely perform fusion streaming, and the system can determine appropriate avatar movements without relying on the front camera. Thereby, the burden on the streamer when performing fusion streaming can be reduced or eliminated.

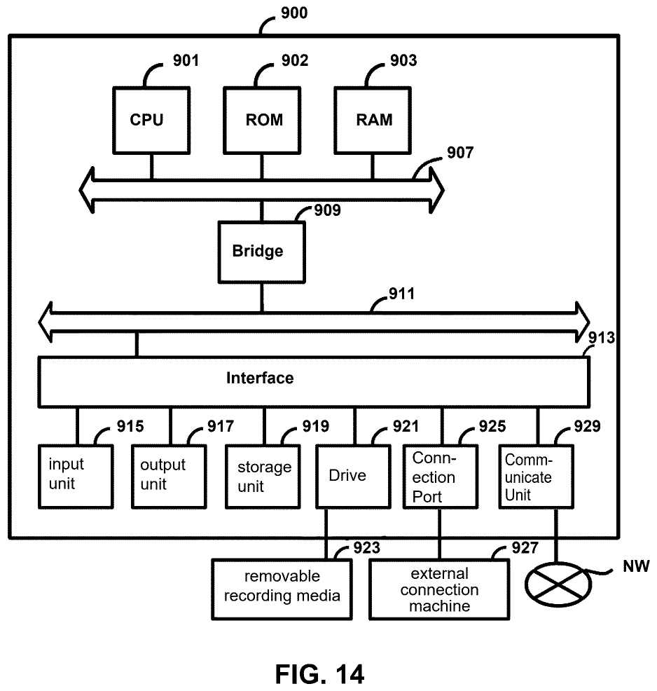

The hardware configuration of the information processing apparatus according to the present embodiment will be described with reference to FIG. 14. FIG. 14 is a block diagram showing a hardware configuration example of the information processing apparatus according to the present embodiment. The illustrated information processing apparatus 900 can realize, for example, each of the server 10 and the user terminals 20 and 30 in the present embodiment.

The information processing apparatus 900 includes a CPU 901, a ROM (Read Only Memory) 902, and a RAM (Random Access Memory) 903. Also, the information processing apparatus 900 may include a host bus 907, a bridge 909, an external bus 911, an interface 913, an input device 915, an output device 917, a storage device 919, a drive 921, a connection port 925, and a communication device 929. Furthermore, the information processing apparatus 900 includes an imaging device (not shown) such as a camera. The CPU 901 is an example of a hardware configuration for realizing functions realized by the components described in this specification. The functions described in this specification may be realized by circuitry programmed to realize said described functions. The circuitry programmed to realize the functions described in this specification includes a CPU (a Central Processing Unit), a DSP (Digital Signal Processor), a general-purpose processor, an application-specific processor, an integrated circuit, ASICs (Application Specific Integrated Circuits), and/or combinations thereof. In this specification, a unit that realizes a specific function may be realized as a circuit programmed to realize said function.

The CPU 901 functions as an arithmetic processing unit and a control unit, and controls the overall operation or a part thereof within the information processing apparatus 900 according to various programs recorded in the ROM 902, the RAM 903, the storage device 919, or a removable recording medium 923. For example, the CPU 901 controls the overall operations of each functional unit included in each of the server 10 and the user terminals 20 and 30 in the present embodiment. The ROM 902 stores programs, operation parameters, etc., used by the CPU 901. The RAM 903 temporarily stores programs used in the execution of the CPU 901, parameters that change appropriately in that execution, etc. The CPU 901, ROM 902, and RAM 903 are mutually connected by a host bus 907 configured by an internal bus such as a CPU bus. Furthermore, the host bus 907 is connected to an external bus 911 such as a PCI (Peripheral Component Interconnect/Interface) bus via a bridge 909.

The input device 915 may be, for example, a device operated by a user such as a mouse, a keyboard, a touch panel, buttons, switches, and levers, or may be a device that converts physical quantities into electrical signals such as a sound sensor like a microphone, an acceleration sensor, a tilt sensor, an infrared sensor, a depth sensor, a temperature sensor, a humidity sensor, etc. The input device 915 may be, for example, a remote control device utilizing infrared rays or other radio waves, or may be an external connection equipment 927 such as a mobile phone corresponding to the operation of the information processing apparatus 900. The input device 915 includes an input control circuit that generates an input signal based on information input by the user or a sensed physical quantity and outputs it to the CPU 901. By operating this input device 915, the user inputs various data or instructs processing operations to the information processing apparatus 900.

The output device 917 is configured by a device capable of visually or auditorily notifying obtained information to the user. The output device 917 can be, for example, a display such as an LCD, PDP, OELD, an audio output device such as a speaker and headphones, and a printer device. The output device 917 outputs results obtained by the processing of the information processing apparatus 900 as video such as text or images, or outputs as sound such as audio.

The storage device 919 is a device for data storage configured as an example of a storage unit of the information processing apparatus 900. The storage device 919 is configured by, for example, a magnetic storage unit device such as an HDD (Hard Disk Drive), a semiconductor storage device, an optical storage device, or a magneto-optical storage device. This storage device 919 stores programs executed by the CPU 901, various data, and various data obtained from the outside.

The drive 921 is a reader/writer for the removable recording medium 923 such as a magnetic disk, an optical disk, a magneto-optical disk, or a semiconductor memory, and is built into or externally attached to the information processing apparatus 900. The drive 921 reads information recorded on the mounted removable recording medium 923 and outputs it to the RAM 903. Also, the drive 921 writes records to the mounted removable recording medium 923.

The connection port 925 is a port for directly connecting equipment to the information processing apparatus 900. The connection port 925 can be, for example, a USB (Universal Serial Bus) port, an IEEE1394 port, a SCSI (Small Computer System Interface) port, etc. Also, the connection port 925 may be an RS-232C port, an optical audio terminal, an HDMI (registered trademark) (High-Definition Multimedia Interface) port, etc. By connecting the external connection equipment 927 to the connection port 925, various data can be exchanged between the information processing apparatus 900 and the external connection equipment 927.

The communication device 929 is a communication interface configured by, for example, a communication device for connecting to the network NW. The communication device 929 can be, for example, a communication card for wired or wireless LAN (Local Area Network), Bluetooth (registered trademark), or WUSB (Wireless USB). Also, the communication device 929 may be a router for optical communication, a router for ADSL (Asymmetric Digital Subscriber Line), or a modem for various communications. The communication device 929 transmits and receives signals and the like using a predetermined protocol such as TCP/IP, for example, with the internet or other communication equipment. Also, the communication network NW connected to the communication device 929 is a network connected by wire or wirelessly, and is, for example, the internet, a home LAN, infrared communication, radio wave communication, or satellite communication. Note that the communication device 929 realizes the function as a communication unit.

The imaging device (not shown) such as a camera is a device that images real space using an imaging element such as a CCD (Charge Coupled Device) or CMOS (Complementary Metal Oxide Semiconductor) and various members such as a lens for controlling image formation of a subject image onto the imaging element, and generates a captured image. The imaging device may be one that captures still images or one that captures moving images.

The configuration and operation of the live streaming system 1 according to the embodiment have been described above. This embodiment is an example, and it is understood by those skilled in the art that various modifications are possible in the combination of each component and each process, and that such modifications are also within the scope of the present disclosure.

In the embodiment, a case where the movement of the avatar is controlled based on audio has been described, but the invention is not limited to this, and instead of/in addition to audio, the movement of the avatar may be controlled based on data other than image data of the front camera, such as content of live streaming, comments from viewers, live streaming events, live streaming scores, gifting, etc.

The conversion rate from consideration points of a gift to granted remuneration in the embodiment is an example, and these may be appropriately set by the administrator of the live streaming system, for example.

The technical idea according to the embodiment may be applied to live commerce.

In the processing procedures described in this specification, particularly in the processing procedures described using flow diagrams and flowcharts, it is possible to omit a part of the steps constituting the processing procedure, add steps not explicitly stated as steps constituting the processing procedure, and/or swap the order of said steps, and processing procedures with such omissions, additions, and order changes are also included in the scope of the present disclosure as long as they do not deviate from the spirit of the present disclosure.

At least a part of the functions realized by the server 10 may be realized by devices other than the server 10, for example, the user terminals 20 and 30. At least a part of the functions realized by the user terminals 20 and 30 may be realized by devices other than the user terminals 20 and 30, for example, the server 10. For example, the streamer's user terminal may have the data of the streamer's avatar and have functions similar to the audio analysis unit 326, the movement determination unit 328, and the synthesis unit 330. In this case, the streamer's user terminal generates synthesized data and streams it to the server 10, and the server 10 receives the synthesized data and transmits it to (i.e., relays it to) the viewer's user terminal. Alternatively, the streamer's user terminal 20 and the viewer's user terminal 30 may each have the function of the synthesis unit 330. In this case, each user terminal 20, 30 has the data of the avatar (by download, etc.), and the server 10 transmits data specifying the movement determined by the movement determination unit 328 to each user terminal 20, 30. Each user terminal 20, 30 performs synthesis and rendering so that the avatar realizes the specified movement.

We claim:

1. A server comprising a circuitry, wherein the circuitry is configured to:
receive, from a mobile terminal via a network, image data obtained from a rear camera of the mobile terminal of a streamer of a live stream and audio data obtained from a microphone of the mobile terminal;
determine a movement of an avatar of the streamer based on the obtained audio data; and
synthesize the obtained image data and data of the avatar such that the avatar is superimposed on an image represented by the obtained image data and the avatar realizes the determined movement.

2. The server according to claim 1, wherein the circuitry is further configured to transmit data obtained as a result of the synthesis to a terminal of a viewer of the live stream via the network.

3. The server according to claim 2, wherein the circuitry is configured to transmit the data obtained as a result of the synthesis to the mobile terminal of the streamer via the network.

4. The server according to claim 1, wherein the circuitry is configured to determine the movement of the avatar based on a volume of audio represented by the obtained audio data.

5. The server according to claim 4, wherein the circuitry is configured to change a display mode of a mouth of the avatar when the volume of the audio represented by the obtained audio data exceeds a threshold value.

6. The server according to claim 1, wherein the circuitry is configured to determine the movement of the avatar based on content of audio represented by the obtained audio data.

7. The server according to claim 6, wherein the circuitry is configured to determine the movement of the avatar according to an emotion of the streamer obtained by analyzing the content of the audio represented by the obtained audio data.

8. The server according to claim 1, wherein the circuitry is configured to determine the movement of the avatar according to a context of conversation in the live stream obtained by analyzing content of audio represented by the obtained audio data and/or a comment posted by a viewer in the live stream.

9. The server according to claim 1, wherein when a predetermined command is detected in the obtained audio data, the circuitry is configured to determine the movement of the avatar corresponding to said command.

10. The server according to claim 1,
wherein the mobile terminal has the rear camera and a front camera, and
wherein the server further comprises a deactivating unit configured to deactivate the front camera during the live stream.

11. The server according to claim 1,
wherein the mobile terminal has the rear camera and a front camera, and
wherein the determining unit determines the movement of the avatar without using information obtained by the front camera.

12. A method, including:
receiving, from a mobile terminal via a network, image data obtained from a rear camera of the mobile terminal of a streamer of a live stream and audio data obtained from a microphone of the mobile terminal;
determining a movement of an avatar of the streamer based on the obtained audio data; and
synthesizing the obtained image data and data of the avatar such that the avatar is superimposed on an image represented by the obtained image data and the avatar realizes the determined movement.

13. A mobile terminal of a streamer of a live stream, comprising:
a rear camera;
a front camera;
a microphone;
a display;
one or more processors; and
memory storing one or more computer programs configured to be executed by the one or more processors,
the one or more computer programs including instructions for:
transmitting image data obtained from the rear camera to a server via a network;
deactivating the front camera during the live stream;
transmitting audio data obtained from the microphone to the server via the network; and
causing the display to display an image in which an avatar is superimposed on an image represented by the transmitted image data and the avatar realizes a movement determined based on the transmitted audio data.
